(19) United States
(12) Patent Application Publication
(10) Pub. No.: US 2007/0096589 A1
(43) Pub. Date: May 3, 2007

(54) Electric machine rotor fan and pole retention feature

(76) Inventor: Michael T. York, Pendleton, IN (US)

Correspondence Address: CANTOR COLBURN, LLP, 55 GRIFFIN ROAD SOUTH, BLOOMFIELD, CT, 06002, US

(21) Appl. No.: 11/263,252

(22) Filed: Oct. 31, 2005

(51) Int. Cl. H02K 9/06; H02K 1/22; H02K 9/00

(52) U.S. Cl. 310/263; 310/63; 310/261

(57) ABSTRACT

Disclosed herein is a rotor assembly for an electric machine which includes a shaft having a slip ring end. A first pole segment rotatable with the shaft. A second pole segment rotatable with the shaft. A slip ring end fan disposed adjacent to the second pole segment and rotatable with the shaft. And, a ring adjacent to the slip ring end fan, press fitted onto the slip ring end of the shaft and rotatable with the shaft, wherein the ring is press fitted to the shaft contacts the slip ring end fan and applies a clamping force to the slip ring end fan.

### TECHNICAL FIELD

The application relates generally to an electrical apparatus. More specifically, this application relates to securing a rotor fan to a rotor assembly for an electric machine.

### BACKGROUND OF THE INVENTION

Electric machines are found in virtually every motor vehicle manufactured today. These electric machines, also referred to as alternators, produce electricity necessary to power vehicle electrical accessories, as well as to charge a vehicle's battery. Electric machines must also provide the capability to produce electricity in sufficient quantities to power a vehicle's electrical system in a manner that is compatible with the vehicle electrical components. Proper airflow and cooling is critical to improve heat dissipation and thus efficiency of the electric machine. One method to improve heat dissipation is to provide cooling fans within the electric machine to create a cooling airflow along the rotor, stator, and/or rectifier.

Cooling fans are typically attached to the rotor by welding attachment points to either the pole segment face or bobbin towers. Another such method of attaching a cooling fan to a rotor utilizes a shouldered shaft to trap the fan between the shaft shoulder and the pole segment face and thus secure it in place. These conventional methods of attaching cooling fans to rotor shafts leads to a number of disadvantages. Such disadvantages include expensive and labor intensive manufacturing methods. Welding processes typically involve expensive fixturing, frequent equipment maintenance, and strict quality control. Likewise, a shouldered shaft is a more complex configuration as compared to a straight shaft and thus requires significantly more machining time and therefore is more costly to fabricate.

### BRIEF SUMMARY OF THE INVENTION

Disclosed herein is a rotor assembly for an electric machine which includes a shaft having a slip ring end. A first pole segment rotatable with the shaft. A second pole segment rotatable with the shaft. A slip ring end fan disposed adjacent to the second pole segment and rotatable with the shaft. And, a ring adjacent to the slip ring end fan, press fitted onto the slip ring end of the shaft and rotatable with the shaft, wherein the ring is press fitted to the shaft contacts the slip ring end fan and applies a clamping force to the slip ring end fan.

Further disclosed herein is a method for attaching a slip ring end fan to a rotor shaft. A shaft urged through a pole segment. A slip ring end fan is mounted on the shaft adjacent to the pole segment. And, a ring is attached to the shaft, adjacent to the slip ring end fan, wherein the ring is secured in place by a press fit between the linearly knurled portion of the shaft and an inside diameter of the ring, wherein a clamping force is applied to the slip ring end fan in response to the attaching of the ring to the shaft.

Yet further disclosed herein is a rotor assembly for a vehicle alternator including a shaft having a slip ring end and a thread end. A first pole segment rotatable with the shaft. A second pole segment rotatable with the shaft. A slip ring end fan disposed adjacent to the second pole segment and rotatable with the shaft. And, a ring adjacent to the slip ring end fan, press fitted onto the slip ring end of the shaft and rotatable with the shaft wherein the ring contacts the slip ring end fan.

### BRIEF DESCRIPTION OF THE DRAWINGS

Referring to the exemplary drawings wherein like elements are numbered alike in the accompanying Figures:

FIG. 1 is a perspective section view of a conventional rotor assembly;

FIG. 2 is a perspective section view of a rotor assembly;

FIG. 3 is a side view of a conventional shaft; and,

FIG. 4 is a side view of a shaft and ring.

### DETAILED DESCRIPTION OF THE INVENTION

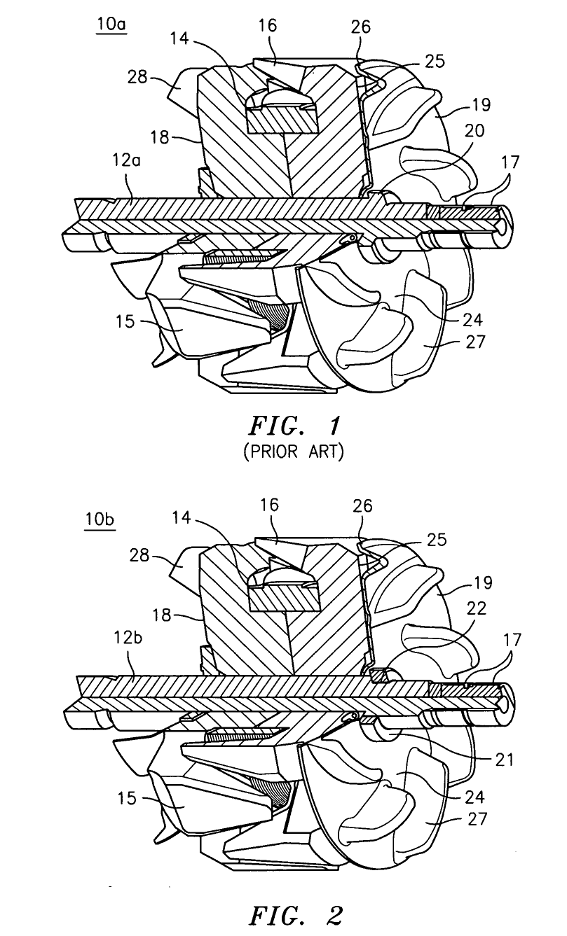

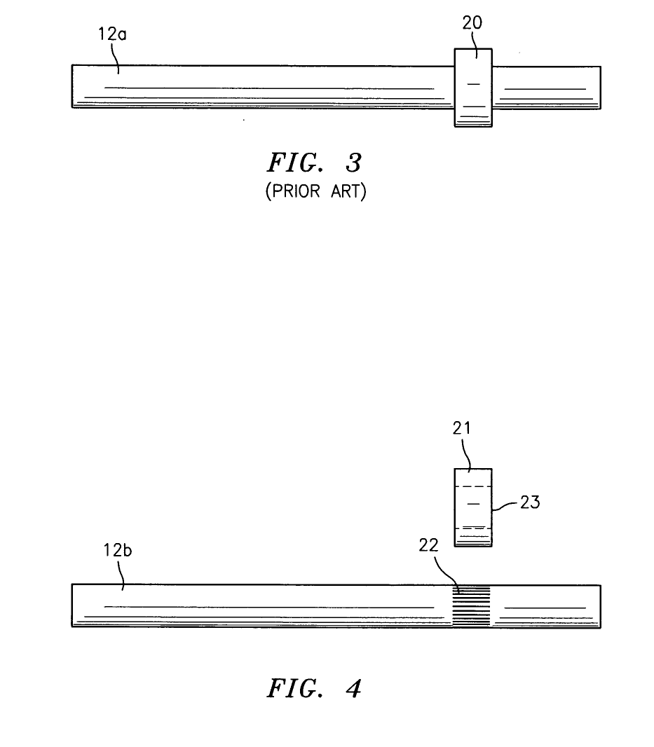

FIG. 1 illustrates a conventional rotor assembly 10a including a shaft 12a, a first pole segment 15, a second pole segment 16, a core (not shown) integral with the pole segments 15 and 16, wherein each pole segment 15 and 16 includes half of the core, a field winding 14 surrounding the core, slip rings 17, a thread end internal fan 18 with integral fan blades 28, and a slip ring end internal fan 19 with integral fan blades 27. The shaft 12a serves as a mounting surface for these components and defines a central axis about which the rotor assembly 10a rotates. The shaft, further illustrated in FIG. 3, includes a shoulder portion 20 integrally formed as part of the shaft 12a. The field windings 14, when energized, create a magnetic field that saturates the surrounding first pole segment 15 and second pole segment 16. The first pole segment 15 and the second pole segment 16 are secured to the shaft 12a and oriented such that the first pole segment 15 is opposed to and interdigitated with the second pole segment 16 as illustrated in FIG. 1.

FIG. 2 illustrates an exemplary embodiment of a rotor assembly 10b, which contains a straight shaft 12b and a press fit ring 21. The straight shaft 12b and the press fit ring 21 are further illustrated in FIG. 4.

The straight shaft 12b has a common diameter substantially throughout the axial length of the shaft 12b, wherein the diameter may vary at different axial points along the axial length of the shaft, does not contain an integral shoulder portion, and is intended to be rotatable within an electric machine. A section of the shaft 12b adjacent to the slip rings 17 contains linear knurls 22, which provide the interface for securing the ring 21 to the shaft 12b. The linear knurls 22 provide a series of raised edges along the circumference of the shaft 12b, which effectively increases the diameter of the shaft 12b in the section of the shaft 12b that contains the linear knurls 22. The ring 21 is installed onto the shaft 12b by guiding the shaft 12b into a through-hole 23 of the ring 21. The diameter of the ring 21 through-hole 23 is configured so that the ring will slide freely along the unknurled portions of the shaft 12b, but will cause an interference fit, or a press fit, when positioned over the section of the shaft 12b that contains the linear knurls 22. The press fit between the inside diameter, or through-hole 23, of the ring 21 and the linear knurls 22 on the shaft 12b secures the ring 21 in a fixed position with respect to the shaft 12b. Alternatively, the linear knurls 22 may be replaced by a smooth larger diameter portion of the shaft 12b wherein, for example, the smooth larger diameter portion may be a diameter similar to the knurl tip diameter of the illustrated embodiment. The smooth larger diameter portion of the shaft 12b would enable the ring to be press fitted to the shaft 12b.

During the assembly process, the slip ring end fan 19 is advanced axially along the shaft 12b until a first face 24 of the slip ring end fan 19 comes into contact with the ring 21. The second pole segment 16 is then mounted axially along the shaft 12b until a first face 25 of the second pole segment 16 comes into contact with a second face, or an outside diameter 26, of the slip ring end fan 19. The slip ring end fan 19 is fabricated to have a cupped shape, wherein the cupped shape open end terminates in the outside diameter 26 of the slip ring end fan 19 and faces the second pole segment 16. The first face 25 of the second pole segment 16 and ring 21 allow for pressure forces, applied during assembly, to act on opposite faces of the slip ring end fan 19 to secure the slip ring end fan 19 in place by compression. In other words, the slip ring end fan 19 is in a sprung relationship with, or tightly clamped between, the first face 25 of the second pole segment 16, interfacing along the outside diameter 26 of the slip ring end fan 19 cupped end, and the ring 21, interfacing along a mating surface of the first face 24 of the slip ring end fan 19. This results in the slip ring end fan 19 being rigidly secured onto the rotor assembly 10b. In an alternative embodiment, the sequence of the assembly process may differ in that the pole segments 15 and 16 are first mounted axially along the shaft 12b, by inserting or pressing the shaft 12b through the pole segments 15 and 16, followed by mounting the slip ring end fan 19 on to the shaft 12b between the second pole segment 16 and the linear knurls 22, and lastly installing the ring 21 over the linear knurls 22, wherein the same sprung relationship between the slip ring end fan 19 and the second pole segment 16 is achieved, thus rigidly securing the slip ring end fan 19 to the rotor assembly 10b.

Further, the disclosed ring 21 may serve as a bearing stop for a slip ring end bearing (not shown). After fabrication of the rotor assembly 10b is complete, the rotor assembly 10b is disposable within an electric machine wherein the ring 21 abuts the slip ring end bearing allowing for fixed axial positioning of the rotor assembly 10b with respect to the electric machine.

Exemplary embodiments of the invention include internal fans such as the thread end fan 18 and the slip ring end fan 19 which may be manufactured by processes including stamping, drawing, or injection molding operations.

The disclosed straight shaft 12b results in several benefits including ease of manufacture, reduced machining time and cost, and greater freedom with respect to fan blade 27 configuration without the concern for welding positions or welding tooling.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A rotor assembly for an electric machine comprising:
a shaft having a slip ring end;
a first pole segment rotatable will a the shaft;
a second pole segment rotatable with the shaft;
a slip ring end fan disposed adjacent to the second pole segment and rotatable with the shaft; and,
a ring adjacent to the slip ring end fan, press fitted onto the slip ring end of the shaft and rotatable with the shaft wherein the ring contacts the slip ring end fan and applies a clamping force to the slip ring end fan.

2. The rotor assembly of claim 1 wherein the shaft includes linear knurls.

3. The rotor assembly of claim 1 wherein the slip ring end fan has a cupped shape open end terminating in an outside diameter of the slip ring end fan.

4. The rotor assembly of claim 1 wherein the shaft is a non-shouldered shaft having a substantially common diameter along an axial length of the shaft.

5. The rotor assembly of claim 1 wherein the ring abuts a slip ring end bearing when the rotor assembly is disposed within an electric machine: wherein the ring serves as a bearing stop for the slip ring end bearing.

6. The rotor assembly of claim 1 further comprising a core wherein a first half of the core is integral to the first pole segment and a second half of the core is integral to the second pole segment.

7. The rotor assembly of claim 1 wherein the slip ring end fan is an internal fan.

8. The rotor assembly of claim 1 further comprising a thread end internal fan adjacent to the first pole segment.

9. The rotor assembly of claim 1 wherein the slip ring end fan is formed by performing a drawing operation.

10. The rotor assembly of claim 1 wherein the slip end fan is formed by performing a stamping operation.

11. The rotor assembly of claim 1 wherein the slip end fan is formed by performing an injection molding operation.

12. A method for attaching a slip ring end fan to a rotor assembly, the method comprising:
urge a shaft through a pole segment;
mounting a slip ring end fan on the shaft adjacent to the pole segment; and,
attaching a ring to the shaft, adjacent to the slip ring end fan, wherein the ring is secured in place by a press fit between a portion of the shaft and an inside diameter of the ring, wherein a clamping force is applied to the slip ring end fan in response to the attaching of the ring to the shaft.

13. A rotor assembly for a vehicle alternator comprising:
a shaft having a slip ring end and a thread end;
a first pole segment rotatable with the shaft;
a second pole segment rotatable with the shaft;
a slip ring end fan disposed adjacent to the second pole segment and rotatable with the shaft; and,
a ring adjacent to the slip ring end fan, press fitted onto the slip ring end of the shaft and rotatable with the shaft wherein the ring contacts the slip ring end fan.

14. The rotor assembly of claim 13 wherein the ring applies a clamping force to the slip ring end fan.

15. The rotor assembly of claim 13 wherein the slip ring end fan has a cupped shape open end terminating in an outside diameter of the slip ring end fan.

16. The rotor assembly of claim 13 wherein the ring abuts a slip ring end bearing when the rotor assembly is disposed within a vehicle alternator; wherein the ring serves as a bearing stop for the slip ring end bearing.

17. The rotor assembly of claim 13 further comprising a core wherein a first half of the core is integral to the first pole segment and a second half of the core is integral to the second pole segment.

18. The rotor assembly of claim 13 the slip ring end fan is formed by performing a drawing operation.

19. The rotor assembly of claim 13 wherein the slip end fan is formed by performing a stamping operation.

20. The rotor assembly of claim 13 wherein the slip end fan is formed by performing an injection molding operation.
